(19) United States
(12) Patent Application Publication
(10) Pub. No.: US 2005/0265244 A1
(43) Pub. Date: Dec. 1, 2005

(54) Overload protection of a TMN system

(76) Inventors: Nils Fischbeck, Stralsund (DE); Leslie Leder, Greifswald (DE); Andreas Stuhr, Poggendorf (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/122,594

(22) Filed: May 5, 2005

(30) Foreign Application Priority Data
May 5, 2004 (EP) EP04010715

(51) Int. Cl. H04L 12/26

(52) U.S. Cl. 370/241

(57) ABSTRACT

To protect an overloading of a central controller OS of a TMN system, messages N received by network elements are assigned to different classes, thereby resulting in class specific loads. Those messages N which are assigned a class K with a class specific load overloading the controller are protected. Messages N can thus be advantageously protected with the aid of their significance for the operator of a telecommunication network, in which rather insignificant messages N are protected in an overload situation and unprotected for important messages N.

### CROSS REFERENCE TO RELATED APPLICATIONS

This application claims priority to the European application No. 04010715.3, filed May 5, 2004 and which is incorporated by reference herein in its entirety.

### FIELD OF INVENTION

The invention relates to an overload protection of a TMN system.

### SUMMARY OF THE INVENTION

A reference architecture of a telecommunications management network (TMN) for monitoring and controlling a network for telecommunication applications is described in the international standard M.3010 (02/2000) of the ITU T, in which it is assumed that the network controlled by the TMN comprises different types of network elements, which are typically controlled with the aid of different communication mechanisms (i.e protocols, messages, management information, also termed as object model).

This TMN comprises the following functionalities:

Operations Systems Function (OSF), which realizes the ‘actual’ management of the telecommunication network.

Workstation Function (WSF), which serves to display the control processes and the network status for a human user of the TMN.

Network Element Function (NEF), which displays an interface for controlling the telecommunication functions of the network elements. The interface defines the specific communication mechanism of the relevant network element, which is not standardized. The sum of all management information of the NE is termed as Management Information Base (MIB) of the NE.

Transformation Function (TF) which is used to connect components with different communication mechanisms and in particular to interface network elements which do not comprise any standardized NEF to the TMN. They are also referred to in the Standard M.3010 (05/96) as Mediation Function and/or Q-Adaption Function.

The function NEF is typically arranged in a physical manner in a network element (NE), whilst the functions OSF and WSF are typically realized in a so-called Operations System (OS). A Data Communication Network (DCN) for transmitting information can be provided between NE and OS. The transmission follows the principle of the transport service as is described in the lower four layers of the ISO/OSI reference model in the international standard X.200.

The individual TMN functions are typically effected by function specific programs in TMN systems to date. They are implemented using hardware (e.g. Processor, I/O module) which is provided in the devices. This implementation is supported by support software (e.g. Multitasking and/or Multithreading operating system, database system, windows system).

A plurality of NE is typically assigned to an OS in each instance. In this way, the OS is mostly arranged centrally, whilst the NE are decentrally distributed in the network on a plurality of positions.

The efficiency of the TMN functions depends on a plurality of different factors. Said efficiency is not determined only by the implementation of the function specific program, but also by the interaction of the system components mentioned with the function specific programs, and by the temporal and special distribution of interactions and data between the different TMN functions.

By way of example, the decentral NE typically sends the central OS sporadic messages about its own status. The information transmitted with the messages is then visualized in the OM and stored in the database. In the case of an excessively high load from the network, in other words with a temporal collapse of a plurality of messages (also known as ‘Burst’), the processing in the OS decelerates to such an extent that no real-time processing is possible by means of the function OSF and subsequently no real-time visualization is possible by means of the function WSF. This type of clustering of messages occurs for example if a major error occurs in the network and all affected NEs in the network simultaneously send messages to the OS, informing of their being affected.

A past events memory provides for a mechanism to protect against a system overload effected by the flood of messages, which is carried by the OS for each message. The generation of the message is disconnected in the NE if a message is repeated too often in one time interval.

The implementations to date clarify that the conversion of this architecture into concrete solutions and in particular the realization of an overload protection resulting from the developed distribution of the system and the plurality of different system components and requirements displays a high-grade complex technical problem.

The object of the invention is to recognize at least one of the existing problems and to achieve said object for technical action by specifying at least one teaching.

According to knowledge of the invention, only the syntactical identity of messages is considered by the mechanism for overload protection mentioned at the start, whilst the semantic significance of the messages plays no roll for the operator. Furthermore, the problem results in that the operator is not shown messages which are important for him, if they occur too frequently, whilst unimportant messages which occur somewhat more infrequently are further displayed. This behavior of the system is not desired.

In addition, the disconnection of the message generation in the network elements stops the end of the message clustering from being automatically detected, but requires additional interventions in the network, which further load the network on its part and additionally result in an undesired, temporal delay, until the network can be monitored and controlled once again to a full extent.

One solution for the problems recognized according to the invention and advantageous embodiments of this solution are specified in the claims.

A plurality of advantages is connected to this solution which is described in more detail with the aid of exemplary embodiments of the invention.

The semantic significance of the messages can be considered with the overload protection by means of corresponding classification, whereby for example more important messages of a first class are assigned for the operator and less important messages of a second class are assigned for the operator. Since the overload protection is based on a class specific overload, it is possible to determine from different criteria, from when a class specific overload was present, that the messages of the second class are already protected with a low specific load of the second class and that the messages of the first class are only protected with a high specific load of the first class.

The overload protection caters to the priorities of the operator. The messages are not only excluded from further processing in accordance with their frequency, but the significance for the efficiency of the network is also taken into account. This avoids the loss of important messages by the overload protection for the operator. Problems can be solved extremely quickly.

By summarizing several messages into classes of message groups, each message is not handled in isolation. An overload situation in the OS is thus also prevented, if different messages together initially form the overload, each individual message arrived too infrequently, in order to be detected as an overload. Hitherto unrecognized overload situations are thus prevented. The monitoring of the network is in this way more stable and more reliable.

The above-mentioned advantage is particularly good and effective if messages from different network elements are summarized together in a common class.

Notification of the beginning and/or end of the protection of specific messages ensures a corresponding display at the function WSF that the operator is not presented with any incorrect information. Even if the current information is not present and therefore can not be displayed, specified by the protection, at least the last known information can be characterized inter alia as out-of-date or invalid.

The assignment of the messages into classes with the aid of a dynamically configurable scheme allows the overload protection to be adapted during the operation of the OS to the changing requirements and priorities of the operator.

A realization of the overload protection with the aid of event keys, statistical occurrence frequencies and a separate monitor module is extremely sparing on resource, because the implementation of the method requires no repeated processing of the message themselves and is effected discontinually, i.e. with only sporadic access to the hardware and/or support software of the OS.

### BRIEF DESCRIPTION OF THE DRAWINGS

The invention is described below with reference to further exemplary embodiments, which are also displayed in the figures, in which

FIG. 1 shows an exemplary arrangement of the overload protection according to the invention, in an exemplary TMN system, comprising the TMN functions WSF, OSF and NEF, which are arranged in physical devices OS and NE, and

FIG. 2 shows a block diagram of an exemplary realization of the overload protection according to the invention.

Emphasis should be made here on the fact that the embodiments of the invention displayed are not to be understood simply to be seen as exemplary nature and also not restricted thereto despite their partially extremely detailed representation.

### DETAILED DESCRIPTION OF THE INVENTION

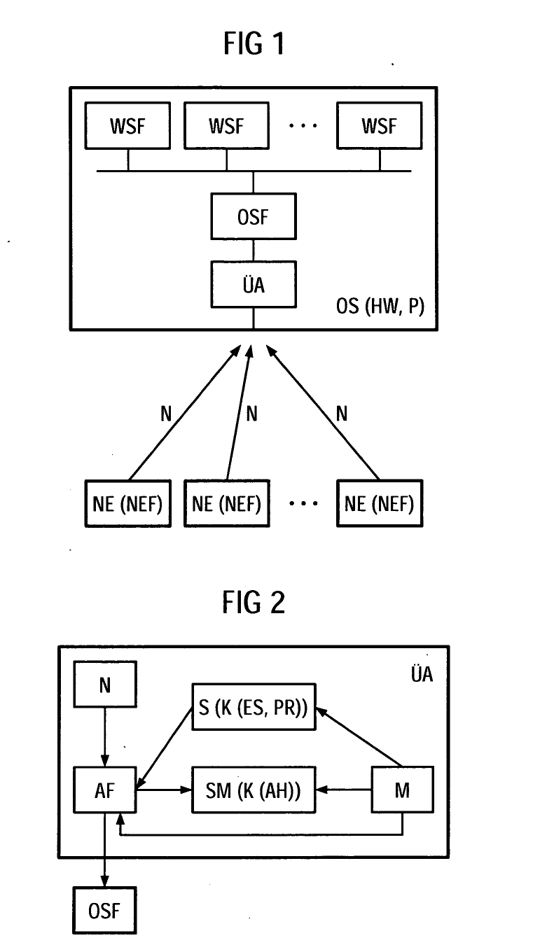

FIG. 1 shows a TMN system of the type mentioned at the start. It comprises the Operations Systems Function Block OSF and Workstation Function WSF and the overload protection ÜA, which are arranged centrally in a product configured as an Operations System OS, and a plurality of Function Blocks NEF, which are arranged decentrally in products configured as network elements. The products comprise Hardware HW for implementing computer program products P, in which the functions are realized. Arrows indicate that messages N are sent from the Network Elements NE to the Operation System OS.

FIG. 2 shows a realization of the overload protection ÜA in a block diagram. This realization for the protection of the Operation System Function OSF by means of messages N comprises a Scheme S, an Adapter/Filter AF, a Statistics Module and/or a Statistics SM and a Monitor M. The overload protection according to the invention is effected in this embodiment of the invention in an event controlled manner, whereby received messages N are interpreted as events.

In scheme S, the grouping and/or formation of classes K of the events is determined for the calculation of event keys ES. It further contains priorities PR. Grouping and priority can be dynamically changed, and the Scheme S can be configured in the Operation System OS.

The Adapter/Filter AF is arranged between the Messages N and the Operations System Function OSF. By means of the Scheme S, an event is assigned an identification configured as a system wide event key ES and a Priority PR, whereby the assignment effects a Class K. The event is identified by its key ES. The identification can be identical for different Messages N and also even if they originate from different objects within a Network Element NE or from different Network Elements NE. Messages N form a message group and/or class K according to their identification. The priority PR determines how important the message N is for the operator. An event is routed to the Statistics Module SM.

The event is registered in the Statistics Module SM, said event being assigned an occurrence frequency AH by means of a time measurement. Incoming messages N are counted in this manner according to priority PR and identification in the statistics SM.

The Monitor M evaluates the data accrued in the statistic module SM. In addition, it monitors the statistic SM in specific time intervals and notifies of an overload for a message group according to configurable rules. In the event of an overload, messages N from this group are not forwarded within the Operation System OS. The message group is blocked and the operation system OS is not further loaded by these message N. Attempts are however not made to suppress the generation of the messages N in the network elements NE. Blocked message groups can be regularly monitored to see whether the overload still applies. If this is no longer the case, the processing is readmitted.

The monitoring can be initiated by means of different mechanisms (for example polling or push). As a function of the frequency AH and the priorities PR the data sets are handled differently in statistic modules SM. If the threshold is too small the data set is deleted. If no statements can be made about the effects, the event is monitored and the data set is actualized with each new event. If the frequency AH is too high, the events relating thereto are then blocked. If the frequency AH falls below the threshold, the blocking stops and the event is only monitored.

As a consequence, an exemplary embodiment of the invention is described, in which the events occur with the same frequency AH but with different priority PR.

In the network, events occur from type A and from type B with approximately the same level of frequency AH. The event A has an occurrence frequency of 13 per second, the event B of 12 per second. These are received in the Operation System OS. In the Adapter Module AF the key ES_{A} is generated for the event A and ES_{B} for the event B by means of the scheme S. A high priority (e.g. with a value 4) is assigned to the event A and a low priority (e.g. with a value 2) is assigned to the event B.

The event keys ES are registered in the Statistics Module SM with the associated Priorities PR. An occurrence frequency AH is stored in an individual data set for each event.

The monitor module M evaluates the occurrence frequency AH for the event and decides whether an event is blocked with the aid of a scheme S. In this example, a frequency threshold 15 is valid for priority 4. The event A is forwarded in the operation system OS, since 13 lies below this threshold. Threshold 10 is for Priority 2, thus blocking event B. Furthermore, in the operation system OS it is notified that event B is now longer processed.

An alternative exemplary embodiment of the invention displays how, with the aid of the invention, several events from different sources together result in an overload or not as a function of the configuration of the scheme S.

It should be assumed that events from ten different sources within a network element NE occur with approximately the same level of frequency 5 and priority 3 at the Operation System OS. The scheme S should be configured such that ten different, distinct event keys ES are generated in the Adapter Module AF. For priority 3, the threshold value 15 is registered in scheme S. The events are subsequently not blocked since the threshold value is not exceeded for each individual event.

Alternatively in the scheme S the assignment of the event key ES should be configured such that the same key ES is calculated for the ten sources. Consequently identical, distinct event keys ES are generated for the events. Therefore an occurrence frequency AH of 50 is calculated in the Statistics Module (SM). Furthermore, the threshold of 15 is exceeded and all events are blocked since it lies above 15.

Finally it should be noted that the description of the components of the TMN system relevant for the invention is basically to be understood as not restricted in terms of the a specific physical realization or assignment. For an appropriate person skilled in the art, it is particularly obvious that all functionalities can be partially or completely realized in a distributed manner in software/computer program products and/or via several physical devices.

1.-11. (canceled)

12. A method for preventing an overload of a central controller, wherein
a plurality of decentral elements are assigned to the controller, wherein
messages are sent from the elements to the controller, wherein
received messages are assigned to different classes, the method comprising:
receiving a message;
assigning the message to a class;
determining a class specific load generated by the message; and
avoiding the message if the class specific load is capable of overloading the controller.

13. The method according to claim 12, wherein the messages are avoided against their forwarding within the controller by blockade.

14. The method according to claim 12, wherein the beginning and/or end of avoiding message classes is notified within the controller.

15. The method according to claim 12, wherein messages from different elements are assigned to the same class.

16. The method according to claim 12, wherein the messages are assigned with the aid of event keys, which are formed with the receipt of messages taking into account a dynamically configurable scheme.

17. The method according to claim 16, wherein the class specific loads are determined with the aid of statistical occurrence frequencies, which are formed taking into account the event keys.

18. The method according to claim 17, wherein the occurrence frequencies are evaluated by a monitor, whereby the evaluation is implemented discontinuously.

19. The method according to claim 18, wherein the evaluation is implemented periodically and/or event-controlled.

20. The method according to claim 12, wherein the overloading, class specific load depends on a priority of the class.

21. The method according to claim 12, wherein the central controller is an Operation System of a Telecommunication Management Network System.

22. The method according to claim 12, wherein the messages are avoided against their forwarding within the controller by discarding.

23. The method according to claim 12, wherein the method is performed by a computer program product adapted to be executed by a processor unit.

24. A product, comprising mechanisms configured to implement the steps of a method according to claim 12.

25. The product according to claim 24, wherein the product is a central controller configured as an operation system of a TMN system.

26. A product comprising:
first means which are set up to implement method steps according to claim 12 effected by the product; and
second means which are set up to implement interactions of the product with further products, wherein remaining method steps of the method according to claim 12 are carried out by the second means.

27. The product according to claim 26, wherein the product is an overload protection unit, a statistics module, a monitor, or an adapter/filter.
